(19) United States
(12) Patent Application Publication
(10) Pub. No.: US 2011/0243518 A1
(43) Pub. Date: Oct. 6, 2011

(54) NON-ZERO DISPERSION SHIFTED FIBER WITH LOW ATTENUATION AND MANUFACTURING METHOD THEREOF

(76) Inventors: Joong-Ho Pi, Seoul (KR); Lae-Hyuk Park, Seoul (KR); Ji-Sang Park, Seoul (KR); Soon-Il Sohn, Gwangmyeong-si (KR)

(21) Appl. No.: 13/078,243

(22) Filed: Apr. 1, 2011

(30) Foreign Application Priority Data
Apr. 1, 2010 (KR) 10-2010-0030011

(51) Int. Cl. G02B 6/028; G02B 6/036; B05D 5/06

(52) U.S. Cl. 385/124; 427/163.2

(57) ABSTRACT

A non-zero dispersion shifted fiber includes a core region, and a clad region located out of the core region. The core region is classified into a plurality of detailed regions in accordance with refractive index contrasts. Among the detailed regions, a region located at a center of the fiber has GeO₂ concentration of 3.5 mol % or less.

### CROSS-REFERENCE TO RELATED APPLICATION

This application claims priority under 35 USC 119(a) to Korean Patent Application No. 10-2010-0030011 filed in Republic of Korea on Apr. 1, 2010, the entire contents of which are incorporated herein by reference.

### BACKGROUND OF THE INVENTION

1. Field of the Invention

The present invention relates to a non-zero dispersion shifted fiber, and more particularly to a non-zero dispersion shifted fiber with low attenuation, which has a structure in which a core region is classified into a plurality of detailed regions in accordance with a refractive index contrast.

2. Description of the Related Art

Among multiplexing methods for optical communications, the WDM (Wavelength Division Multiplexing) technology allows easy expansion of lines and is suitable for high-speed large-capacity communication networks since it divides signal channels and transmits data without any additional installation of optical cables.

In the WDM, DSF (Dispersion Shifted Fiber) is widely used. However, the transmission characteristics of the DSF are deteriorated due to nonlinearities as the luminous intensity of signals is increased, which is a problem to be solved. Such nonlinearities include SRS (Stimulated Raman Scattering) in which the optical power with a short-wavelength signal is transferred to a long-wavelength signal to decrease OSNR (Optical Signal-to-Noise Ratio) and SBS (Stimulated Brillion Scattering) in which the maximum power applicable to optical fibers is limited, which are caused by the stimulated scattering of silica molecules, and SPM (Self-Phase Modulation), XPM (Cross-Phase Modulation), and FWM (Four Wavelength Mixing), which are caused by the nonlinear refractive index. When a channel gap is decreased in a multi-channel communication method such as WDM, there are particularly caused problems in XPM and FWM.

In the FWM, at least two optical waves having different frequencies are coupled in an optical fiber by the third-order electric susceptibility to make a new optical wave with another frequency. This new optical wave is interfered with other channels to cause signal distortion. The FWM becomes maximum when phase matching occurs between the new optical wave and another channel.

The intensity of optical power of a new frequency component generated by the FWM is decreased as the dispersion value and effective area of the optical fiber are increased since the phase mismatching becomes easier.

Thus, an optical fiber used in a WDM system having an increased transmission capacity should have sufficient dispersion capable of controlling the nonlinear phenomenon and also have a minimized dispersion in order to minimize the accumulated dispersion. Also, it is required to control the nonlinear phenomenon and broaden an available wavelength band by increasing the effective area and decreasing the dispersion slope.

According to the above demand, in the conventional art, there has been disclosed NZDSF (Non-Zero Dispersion Shifted Fiber) having a predetermined dispersion value smaller than those of existing single mode optical fibers so that the dispersion does not become zero, thereby decreasing the dispersion in use wavelength bands and decreasing nonlinear phenomena.

FIG. 1 shows essential components of a conventional NZDSF. The part (a) of FIG. 1 is a sectional view showing a core region 1 and a clad region 2 in a radial direction of the NZDSF, and the part (b) of FIG. 1 is a profile schematically showing refractive index contrasts of detailed regions 1a to 1c of the core.

Referring to FIG. 1, the NZDSF includes a core region 1 and a clad region 2 located out of the core region 1. Also, the core region 1 includes a first core 1a, a second core 1b, and a third core 1c, which are located in order in a radial direction from the center.

The first core 1a, the second core 1b, and the third core 1c of the core region 1 have radii r1, r2, and r3, respectively, and refractive index contrasts Δ1, Δ2, and Δ3, respectively. Commonly, the composition of the core region 1 contains impurities such as GeO₂ and F, and P₂O₅ is included for stabilized production. In particular, the first core 1a has GeO₂ concentration of 4.5 to 5.0 mol %.

The core region 1 and the clad region 2 are formed by the clad/core deposition process that is an essential process in MCVD (Modified Chemical Vapor Deposition). In the MCVD, a material gas such as SiCl₄, GeCl₄, and POCl₃ is put into a rotating preform quartz tube together with oxygen, and also the quartz tube is heated while repeatedly reciprocating a heat source along an axial direction of the quartz tube so that reaction products are deposited to an inner wall of the tube by means of thermophoresis to form deposition layers of the clad and the core, by which the deposition process is performed. Here, SiO₂ particles generated by the reaction of the material gas determine diameters of the clad and the core, GeO₂ particles control the refractive index, and P₂O₅ lowers a sintering temperature of the reaction particles.

The NZDSF contains 4.5 mol % or more of GeO₂ in the core region so that a Rayleigh scattering loss is 0.152 dB/km, a loss at 1,550 nm is 0.21 to 0.22 dB/km, and a macro bending loss caused by the bending at 0130 mm/1,625 nm is 0.2 to 0.5 dB/t. Also, at 1,550 nm, the NZDSF has an effective area of 60 to 70 μm², a MFD (Mode Field Diameter) of 9.1 to 10.0 μm, a cable cutoff wavelength of 1,450 nm or less, a zero dispersion of 1,500 nm or less, and a zero dispersion slope of 0.08 or less.

However, in recent, along with the development of optical fiber manufacturing technologies, the attenuation-related specifications demanded by customers tend to be lowered, and accordingly there is demanded an NZDSF with the attenuation less than 0.21 dB/km at 1,550 nm.

### SUMMARY OF THE INVENTION

The present invention is designed to solve the problems of the prior art, and therefore it is an object of the present invention to provide a non-zero dispersion shifted fiber with low attenuation, in which a core region has an improved structure so as to satisfy attenuation characteristics of 0.20 dB/km or less and decrease a bending loss at 1,550 nm.

In one aspect of the present invention, there is provided a non-zero dispersion shifted fiber, which includes a core region; and a clad region located out of the core region, wherein the core region is classified into a plurality of detailed regions in accordance with refractive index contrasts, and wherein, among the detailed regions, a region located at a center of the fiber has GeO₂ concentration of 3.5 mol % or less.

Preferably, the detailed regions of the core region include a first core, a second core, a third core, and a fourth core, which are located in order in a radial direction, and the first core is the region located at the center of the fiber.

Preferably, at least one of the second core, the third core, and the fourth core is free from P₂O₅.

Preferably, the refractive index contrasts of the first core, the second core, the third core, and the fourth core of the core region are defined as Δ1, Δ2, Δ3, and Δ4, respectively, and the refractive index contrasts satisfy the following relation: Δ1>Δ3>Δ2≧Δ4.

Preferably, Δ1=0.46±0.03%, Δ2=−0.10±0.03%, Δ3=0.22±0.03%, and Δ4=−0.16±0.03%.

Preferably, radii of the first core, the second core, the third core, and the fourth core of the core region are defined as r1, r2, r3, and r4, respectively, and r1=2.9±0.6 μm, r2=6.0±0.6 μm, r3=8.3±0.6 μm, and r4=11.5±0.6 μm.

In another aspect of the present invention, there is also provided a method for manufacturing a non-zero dispersion shifted fiber, which performs a deposition process using a material gas containing SiCl₄, GeCl₄, and POCl₃ to produce an optical fiber that includes a core region and a clad region located out of the core region, the core region being classified into a first core, a second core, a third core, and a fourth core in accordance with refractive index contrasts in a radial direction from a center of the core region, wherein the material gas is controlled so that GeO₂ concentration is 3.5 mol % or less when the first core is formed, and wherein the material gas is free from POCl₃ when at least one of the second core, the third core, and the fourth core is formed.

Preferably, when refractive index contrasts of the first core, the second core, the third core, and the fourth core of the core region are defined as Δ1, Δ2, Δ3, and Δ4, respectively, a refractive index of the core region is controlled so that the refractive index contrasts satisfy the following relation: Δ1>Δ3>Δ2≧Δ4.

The non-zero dispersion shifted fiber according to the present invention may have improved attenuation characteristics by minimizing the concentration of impurities at the core region where the intensity of optical power is focused.

Also, the non-zero dispersion shifted fiber according to the present invention may improve a macro bending loss to the level of 0.05 dB/t or less by the bending at Φ30 mm/1,625 nm.

### BRIEF DESCRIPTION OF THE DRAWINGS

Other objects and aspects of the present invention will become apparent from the following description of embodiments with reference to the accompanying drawing in which:

FIG. 1 is a schematic diagram showing a conventional non-zero dispersion shifted fiber; and

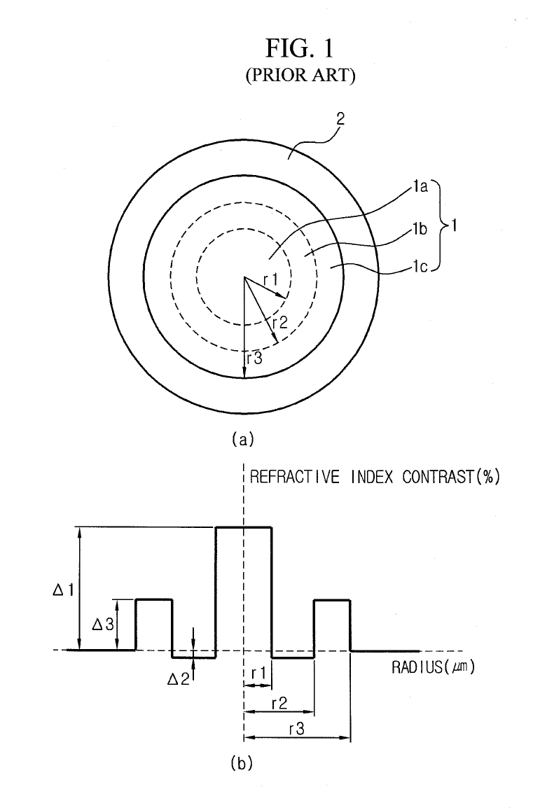

FIG. 2 is a schematic diagram showing a non-zero dispersion shifted fiber according to a preferred embodiment of the present invention.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

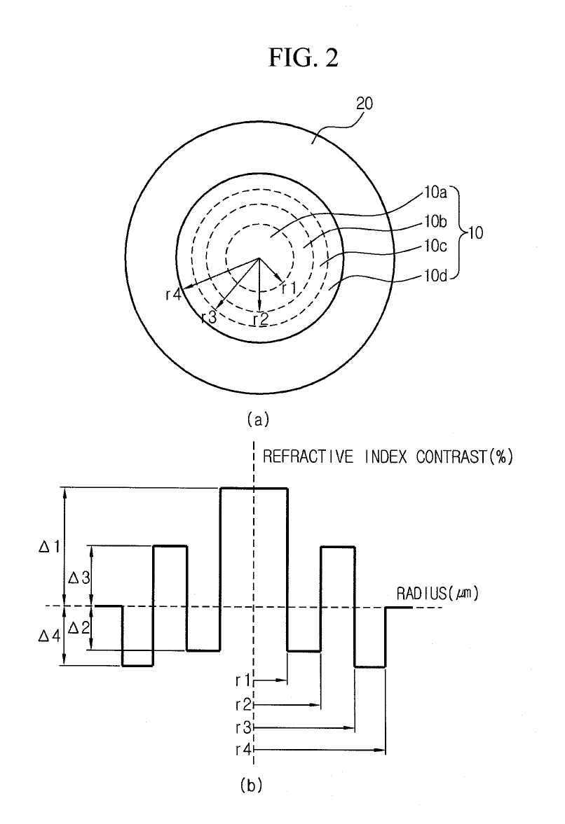

FIG. 2 shows essential parts of a non-zero dispersion shifted fiber (NZDSF) according to a preferred embodiment of the present invention. The part (a) of FIG. 2 is sectional view showing a core region 10 and a clad region 20 of the non-zero dispersion shifted fiber, and the part (b) of FIG. 2 is a schematic view showing a refractive index contrast of detailed regions 10a to 10d of the core.

Referring to FIG. 2, the NZDSF according to the preferred embodiment of the present invention includes a core region 10 having a plurality of detailed regions 10a to 10d and having GeO₂ concentration of 3.5 mol % or less in the detailed region located at the center of the optical fiber, and a clad region 20 located out of the core region 10.

The core region 10 has a plurality of detailed regions, which are classified in accordance with refractive index contrasts in a radial direction from the center. Though it is depicted that the core region 10 is classified into a first core 10a, a second core 10b, a third core 10c, and a fourth core 10d, the number of detailed regions may be varied without being limited to the above. Hereinafter, the present invention will be described based on the embodiment in which the core region 10 is classified into the first core 10a, the second core 10b, the third core 10c, and the fourth core 10d.

The core region 10 contains impurities such as GeO₂ and F due to GeCl₄ or the like that is added for controlling the refractive index when an optical fiber preform is produced. In order to minimize the attenuation caused by Rayleigh scattering, among the detailed regions, the first core 10a located at the center of the optical fiber and the second core 10b adjacent to the first core 10a are configured to contain a small amount of impurities.

In particular, the first core 10a that is a core area having a concentrated intensity of optical power and including MDF of about 9.6 μm contains GeO₂ at a concentration of 3.5 mol % or less. By using this composition, it is possible to obtain a loss quality of 0.20 dB/km at 1,550 nm since the loss characteristic caused by Rayleigh scattering is improved to the level of about 0.135 dB/km, while greatly decreasing the amount of expensive Ge in comparison to the conventional cases. In a case where the concentration of GeO₂ contained in the first core 10a exceeds 3.5 mol %, the optical loss at 1,550 nm becomes 0.21 dB/km or above, which may greatly deteriorate the quality of transmission.

In order that the first core 10a has the GeO₂ concentration of 3.5 mol % or less, the detailed regions 10b to 10d located out of the first core 10a should have smaller refractive indexes in comparison to the first core 10a. For this purpose, the second core 10b and the third core 10c are configured not to have P₂O₅. In other words, POCl₃ that is added to lower a sintering temperature of reaction particles when producing an optical fiber preform is excluded when forming the second core 10b and the third core 10c so that the second core 10b and the third core 10c have compositions free from P₂O₅.

If POCl₃ is added when producing an optical fiber preform, the viscosity of the preform is gradually lowered to ensure deposition at a stable temperature, and the preform produced in this way has an increased refractive index as tension is applied during a drawing process. On the contrary, in a case where the viscosity is increased by excluding POCl₃ from the material gas when producing an optical fiber preform, the change of refractive index caused by tension during a drawing process is suppressed. Thus, if POCl₃ is excluded when forming the second core 10b and the third core 10c, the refractive indexes of the second core 10b and the third core 10c may be decreased, and thus, though the GeO₂ concentration of the first core 10a is lowered to the level of 3.5 mol % or less, the refractive index of the first core 10a may be maintained higher than those of the second core 10b and the third core 10c.

In order to further decrease the bending loss, the fourth core 10d is formed to have a lower refractive index than that of the second core 10b. In order to decrease the refractive index, POCl₃ is excluded during a deposition process for forming the fourth core 10d, and fluorine (F) is preferably added.

In the present invention, the refractive index contrasts of the first core 10a, the second core 10b, the third core 10c, and the fourth core 10d preferably satisfy the following relation: Δ1>Δ3>Δ2≧Δ4. Δ1, Δ2, Δ3, and Δ4 respectively represent refractive index contrasts of the first core 10a, the second core 10b, the third core 10c, and the fourth core 10d. Assuming that refractive indexes of the first core 10a, the second core 10b, the third core 10c, and the fourth core 10d are respectively n1, n2, n3, and n4, and the refractive index of the clad region 20 is nc1, the refractive index contrasts are defined as follows: Δ1=(n1−nc1)/nc1×100[%], Δ2=(n2−nc1)/nc1×100[%], Δ3=(n3−nc1)/nc1×100[%], and Δ4=(n4−nc1)/nc1×100[%].

In order to provide excellent loss characteristics and excellent dispersion characteristics while satisfying the ITU-T G.655.A optical fiber standards, the refractive index contrasts are preferably defined as follows: Δ1=0.46±0.03%, Δ2=−0.10±0.03%, Δ3=0.22±0.03%, and Δ4=−0.16±0.03%. Here, assuming that radii of the first core 10a, the second core 10b, the third core 10c, and the fourth core 10d are respectively r1, r2, r3, and r4, the radii are preferably defined as follows: r1=2.9±0.6 μm, r2=6.0±0.6 μm, r3=8.3±0.6 μm, and r4=11.5±0.6 μm.

In the non-zero dispersion shifted fiber having the above configuration, the first core 10a satisfies the GeO₂ concentration condition of 3.5 mol % or less, and thus Rayleigh loss is in the level of 0.135 to 0.138 dB/km, which is decreased in comparison to the conventional cases. Thus, the loss characteristic at 1,550 nm becomes 0.20 dB/km or less. Also, a macro bending loss caused by the bending at Φ30 mm/1,625 nm becomes in the level of 0.05 dB/t or less, the effective area at 1,550 nm is 55 to 70 μm², the MFD is 9.1 to 10.0 μm, the cable cutoff wavelength is 1,310 nm or less, the zero dispersion is 1,500 nm or less, and the zero dispersion slope is 0.08 or less.

The following table 1 shows detailed design values of the non-zero dispersion shifted fibers according to examples 1 to 3 of the present invention, which satisfy the above conditions, and the following table 2 shows loss characteristics and dispersion characteristics according to the design values. Here, the first core 10a is composed to have GeO₂ concentration of 3.5 mol % or less, and the second core 10b and the third core 10c are composed not to contain P₂O₅.

TABLE 1

| | r1 [um] | r2 [um] | r3 [um] | r4 [um] | rcl [um] | Δ1 [%] | Δ2 [%] | Δ3 [%] | Δ4 [%] |
|---|---|---|---|---|---|---|---|---|---|
| Example | 3.0 | 6.1 | 8.4 | 11.7 | 62.5 | 0.48 | −0.08 | 0.22 | −0.14 |
| 1 | | | | | | | | | |
| Example | 3.0 | 6.1 | 8.4 | 11.7 | 62.5 | 0.44 | −0.09 | 0.22 | −0.19 |
| 2 | | | | | | | | | |
| Example | 3.2 | 6.5 | 8.4 | 12.0 | 62.5 | 0.43 | −0.08 | 0.22 | −0.18 |
| 3 | | | | | | | | | |

TABLE 2

| | | | | Rayleigh | Cutoff | | | | | | |
|---|---|---|---|---|---|---|---|---|---|---|---|
| | Drawing | Effective | Loss | Scattering | wavelength | MFD | Dispersion | | | | Bending |
| | tension | area | @1550 | Loss | @Cable | @1550 | characteristics | | | | @1625 |
| | [g] | [μm²] | [dB/km] | [dB/km] | [nm] | [μm] | λ0 | 1550 | 1625 | Slope | (Φ30) |
| Example | 390 | 59 | 0.198 | 0.138 | 1224 | 9.12 | 1482 | 4.4 | 9.4 | 0.065 | 0.021 |
| 1 | | | | | | | | | | | |
| Example | 350 | 65 | 0.195 | 0.135 | 1203 | 9.49 | 1480 | 4.7 | 10.2 | 0.072 | 0.005 |
| 2 | | | | | | | | | | | |
| Example | 375 | 62 | 0.196 | 0.135 | 1201 | 9.31 | 1479 | 4.4 | 9.5 | 0.067 | 0.001 |
| 3 | | | | | | | | | | | |

Seeing the tables 1 and 2, it could be understood that the non-zero dispersion shifted fibers according to the examples 1 to 3 of the present invention satisfy the numerical ranges of the radii and refractive index contrasts of the first to fourth core 10a to 10d and thus exhibit high-quality loss characteristics and dispersion characteristics, which are applicable to WDM (Wavelength Division Multiplexing) optical communications.

The non-zero dispersion shifted fiber configured as above is manufactured by a preform producing process in which a material gas containing SiCl₄, GeCl₄ and POCl₃ is put into a quartz tube together with oxygen and also a heat source is moved in a length direction of the quartz tube to deposit a clad and a core, and a following drawing process.

In particular, in the core depositing process, the refractive index is controlled so that the first core 10a, the second core 10b, the third core 10c, and the fourth core 10d may be classified depending on refractive index contrasts in a radial direction from the center. At this time, when the first core 10a is formed, the material gas is controlled so that the GeO₂ concentration becomes 3.5 mol % or less, and when the second core 10b and the third core 10c are formed, POCl₃ is excluded from the material gas so that the refractive indexes of the second core 10b and the third core 10c are controlled lower than that of the first core 10a.

In addition, when the first core 10a, the second core 10b, the third core 10c, and the fourth core 10d are formed, the refractive index of each detailed region of the core is controlled by adjusting the material gas to manufacture a non-zero dispersion shifted fiber that has refractive index contrasts satisfying the relation of Δ1>Δ3>Δ2≧Δ4.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, it is possible to realize a non-zero dispersion shifted fiber that satisfies the ITU-T G.655.A optical fiber standards and has improved loss characteristics to the level of 0.20 dB/km or less at 1,550 nm.

What is claimed is:

1. A non-zero dispersion shifted fiber, comprising:
a core region; and
a clad region located out of the core region,
wherein the core region is classified into a plurality of detailed regions in accordance with refractive index contrasts, and
wherein, among the detailed regions, a region located at a center of the fiber has GeO₂ concentration of 3.5 mol % or less.

2. The non-zero dispersion shifted fiber according to claim 1,
wherein the detailed regions of the core region include a first core, a second core, a third core, and a fourth core, which are located in order in a radial direction, and
wherein the first core is the region located at the center of the fiber.

3. The non-zero dispersion shifted fiber according to claim 2, wherein at least one of the second core, the third core, and the fourth core is free from P₂O₅.

4. The non-zero dispersion shifted fiber according to claim 1,
wherein the refractive index contrasts of the first core, the second core, the third core, and the fourth core of the core region are defined as Δ1, Δ2, Δ3, and Δ4, respectively, and
wherein the refractive index contrasts satisfy the following relation: Δ1>Δ3>Δ2≧Δ4.

5. The non-zero dispersion shifted fiber according to claim 4, wherein Δ1=0.46±0.03%, Δ2=−0.10±0.03%, Δ3=0.22±0.03%, and Δ4=−0.16±0.03%.

6. The non-zero dispersion shifted fiber according to claim 5,
wherein radii of the first core, the second core, the third core, and the fourth core of the core region are defined as r1, r2, r3, and r4, respectively, and
wherein r1=2.9±0.6 μm, r2=6.0±0.6 μm, r3=8.3±0.6 μm, and r4=11.5±0.6 μm.

7. A method for manufacturing a non-zero dispersion shifted fiber, which performs a deposition process using a material gas containing SiCl₄, GeCl₄, and POCl₃ to produce an optical fiber that includes a core region and a clad region located out of the core region, the core region being classified into a first core, a second core, a third core, and a fourth core in accordance with refractive index contrasts in a radial direction from a center of the core region,
wherein the material gas is controlled so that GeO₂ concentration is 3.5 mol % or less when the first core is formed, and
wherein the material gas is free from POCl₃ when at least one of the second core, the third core, and the fourth core is formed.

8. The method for manufacturing a non-zero dispersion shifted fiber according to claim 7,
wherein, when refractive index contrasts of the first core, the second core, the third core, and the fourth core of the core region are defined as Δ1, Δ2, Δ3, and Δ4, respectively, a refractive index of the core region is controlled so that the refractive index contrasts satisfy the following relation: Δ1>Δ3>Δ2≧Δ4.
